(19) United States
(12) Patent Application Publication
(10) Pub. No.: US 2026/0043446 A1
(43) Pub. Date: Feb. 12, 2026

(54) METHOD OF REFURBISHING A STEEL-SHELL BRAKE DRUM

(71) Applicant: WHEELNZ LLC, Woodland, WA (US)

(72) Inventors: Omar J. Fakhoury, Vancouver, WA (US); John A. Schneider, Woodland, WA (US)

(21) Appl. No.: 19/293,657

(22) Filed: Aug. 7, 2025

Related U.S. Application Data
(60) Provisional application No. 63/681,007, filed on Aug. 8, 2024.

(51) Int. Cl. F16D 65/00; B22D 13/04; B22D 19/10

(52) U.S. Cl. CPC F16D 65/0043; B22D 13/04; B22D 19/10; F16D 2250/0007; F16D 2250/0046

(57) ABSTRACT

A method of refurbishing a steel-shell brake drum that includes superheating a worn-out brake drum until the worn-out brake drum is glowing hot. The worn-out brake drum includes a steel shell and a worn-out, gray-iron layer bonded to an inside surface of the steel shell. The method further includes centrifugal casting additional molten iron to the gray-iron layer to increase the radial thickness of the gray-iron layer.

### CROSS-REFERENCES TO RELATED APPLICATIONS

This patent application claims the benefit of U.S. Provisional Application No. 63/681,007, filed Aug. 8, 2024. Application No. 63/681,007 is incorporated into the present disclosure by this reference.

### TECHNICAL FIELD

The subject matter is related to a method for refurbishing a steel-shell brake drum.

### BACKGROUND

Steel shell (composite) brake drums are a type of S-Cam brake drums that is commonly used on commercial vehicles. Steel shell brake drums are made by using a combination of a steel shell on the outside with a gray-iron layer that is bonded to the inside of the steel shell through a centrifugal casting process.

The current manufacturing process for making steel shell brake drums involves several steps, including roll forming, superheating, centrifugal casting with molten iron, cooling, machining, and painting. Over time, brake drums wear out, exceeding the maximum allowable brake surface diameter. Traditionally, these worn-out drums have been discarded despite the steel shell often remaining intact.

### BRIEF DESCRIPTION OF THE DRAWINGS

FIG. 1 is an isometric view of a worn-out brake drum and a splash dam according to an example configuration.

FIG. 2 is an isometric view of a worn-out brake drum having circumferential grooves and a splash dam installed, according to an example configuration.

FIG. 3 is a plan view from the open end of the brake drum of FIG. 2.

FIG. 4 is a sectional view as defined in FIG. 3.

FIG. 5 is the sectional view of FIG. 4 illustrating additional processing.

FIG. 6 is the sectional view of FIG. 5, but illustrating additional processing.

FIG. 7 illustrates an method of refurbishing a steel-shell brake drum, according to an example configuration.

### DETAILED DESCRIPTION

As described in this document, aspects are directed to a method for refurbishing worn-out steel shell brake drums. The worn-out steel shell brake drums may be, for example, returned from the field after having been in use. Implementations of the method involve superheating the worn-out brake drum, which includes the steel shell and the remaining gray-iron layer, and then using centrifugal casting to introduce a new layer of molten iron to the remaining gray-iron layer. This restores the original braking surface diameter, allowing the drum to be machined to final specifications and then reused. As a result, implementations of this method offer an economical and environmentally friendly solution for extending the service life of brake drums and to reduce waste. Additionally, by refurbishing the existing, worn-out steel shell drums, the overall cost of producing steel shell drums is significantly reduced, making them competitive with standard, cast brake drums.

As noted, the worn-out steel shell brake drums may be received after having been returned from the field following a period of use. In an example implementation, end users are incentivized to return the worn-out steel shell brake drums through a rebate program, encouraging the recycling and refurbishment of used drums.

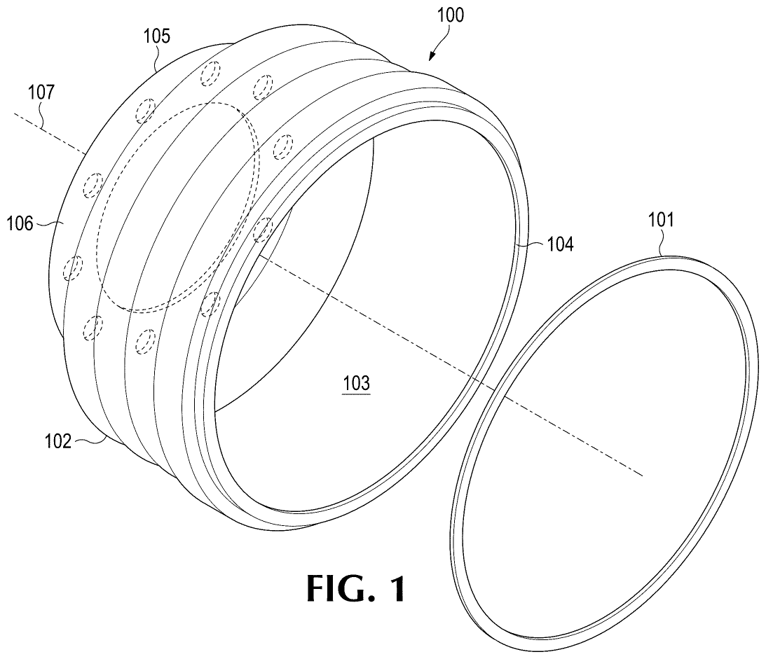

FIG. 1 is an isometric view illustrating aspects a worn-out brake drum 100. FIG. 1 also shows a splash dam 101, according to an example configuration, prior to being installed on the worn-out brake drum 100. As illustrated in FIG. 1, a worn-out brake drum 100 may include a steel shell 102 and a gray-iron layer 103.

The steel shell 102 has an open end 104 and a second end 105 that is axially opposite the open end 104 of the steel shell 102. The second end 105 of the steel shell 102 typically includes an annular flange 106 for bolting the steel shell 102 to a hub which is assembled to a vehicle axle. The steel shell 102, which is roll formed, is generally cylindrical. The steel shell 102 is axisymmetric about an axis of rotation 107. In use, the axis of rotation 107 corresponds to the rotation axis of the vehicle axle to which the steel-shell brake drum is attached.

The gray-iron layer 103 is bonded to an inside surface 108 of the steel shell 102. The gray-iron layer 103 of the worn-out brake drum 100 is “worn out,” meaning that, because the brake drum was previously used, the gray-iron layer 103 has been worn down so that the inner diameter 109 of the gray-iron layer 103 (as indicated by its radius in the drawing) exceeds the maximum allowable brake surface diameter. In other words, there is not enough gray-iron layer 103 to meet industry standards for effective braking because the radial thickness 110 of the gray-iron layer 103 is below the desired threshold.

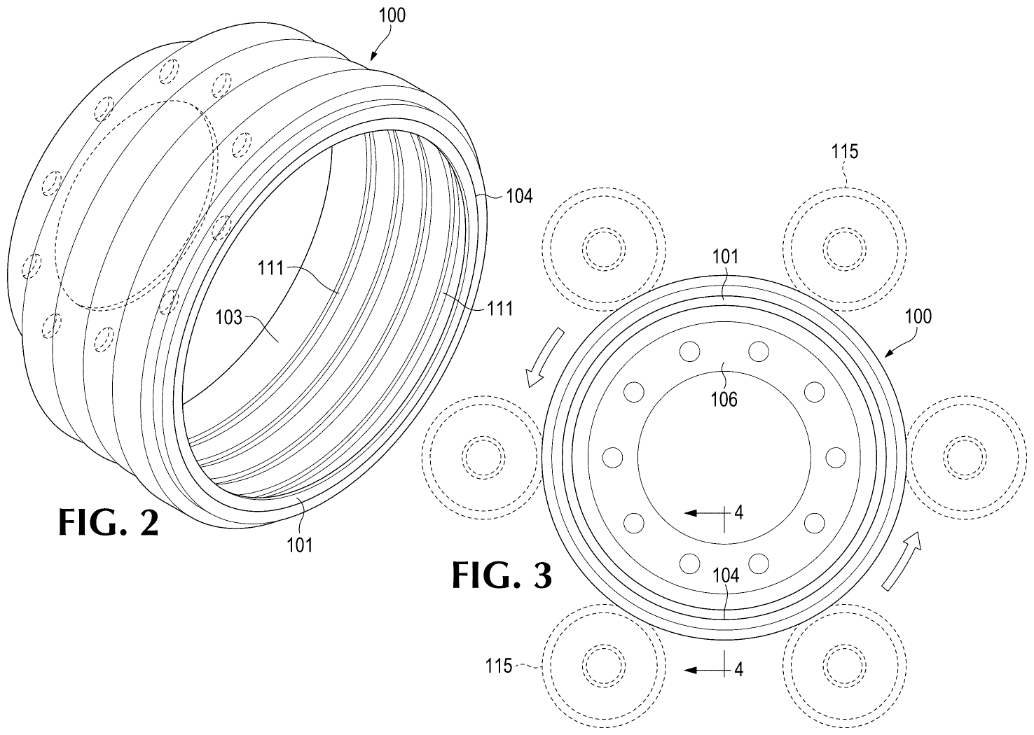

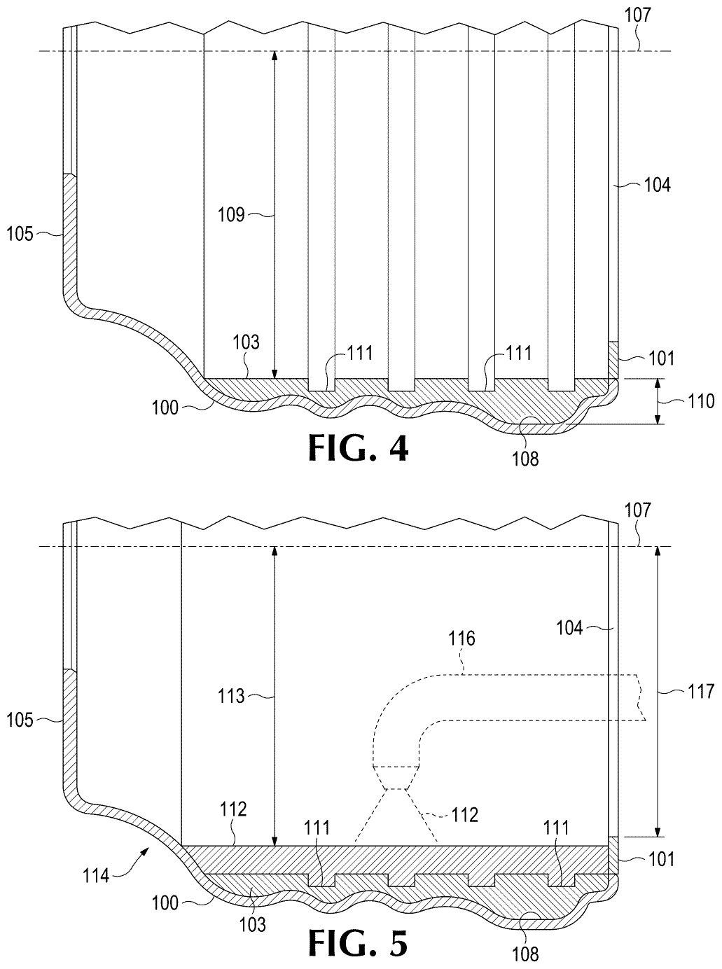

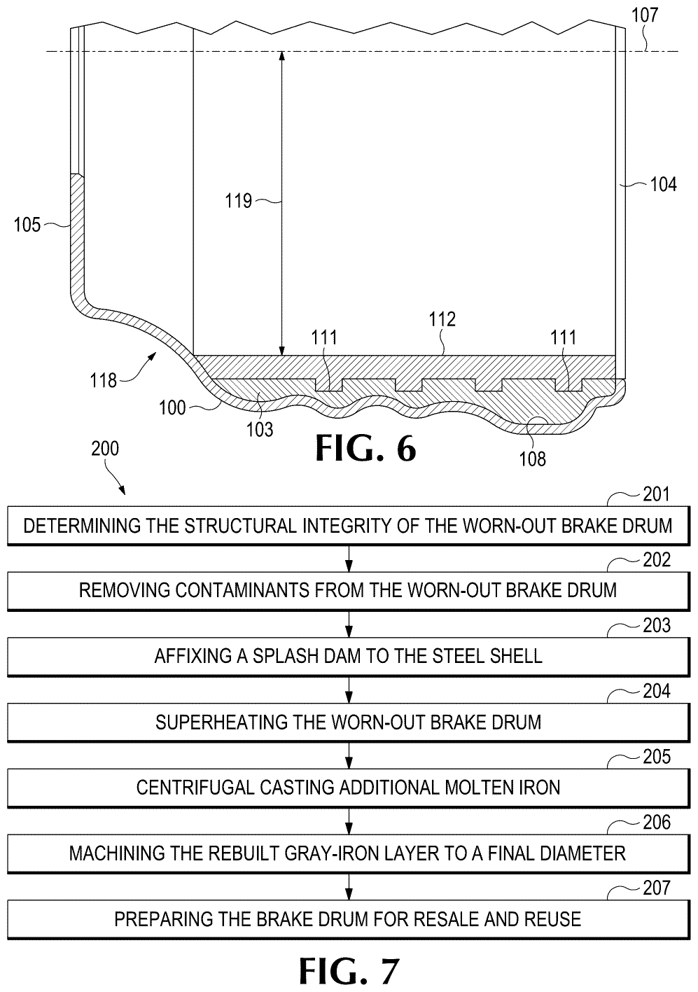

FIG. 2 is an isometric view of a worn-out brake drum 100 having circumferential grooves 111 and a splash dam 101 installed, according to an example configuration. FIG. 3 is a plan view from the open end 104 of the brake drum of FIG. 2. FIG. 4 is a sectional view as defined in FIG. 3. FIG. 5 is the sectional view of FIG. 4, but illustrating additional processing. FIG. 6 is the sectional view of FIG. 5, but illustrating additional processing. FIG. 7 illustrates an example method of refurbishing a steel-shell brake drum.

With continued reference to FIGS. 1-7, a method of refurbishing a steel-shell brake drum includes superheating 204 the worn-out brake drum 100 until the worn-out brake drum 100 is glowing hot. The purpose of the superheating process is to facilitate the bonding of new iron 112 to the existing, worn out, gray-iron layer 103. Accordingly, the precise temperature to which the worn-out brake drum 100 is superheated will depend on the particular worn-out brake drum 100, especially its diameter and mass. The superheating would typically occur in a furnace.

Once the worn-out brake drum 100 has been superheated, the method includes centrifugal casting 205 additional molten iron 112 to the gray-iron layer 103 to increase the radial thickness 110 of the gray-iron layer 103. For convenience, this specification refers to the inner diameter of gray-iron layer 103 plus the additional iron added by this process as the “rebuilt inner diameter” 113 of the gray-iron layer 103 (as indicated by its radius in the drawing). Also for convenience, the resulting brake drum (i.e. the modified worn-out brake drum 100) is subsequently referred to in this specification as a “phase-one brake drum” 114 for ease of referring to this intermediate configuration.

As illustrated, the operation of centrifugal casting includes orienting the worn-out brake drum 100 so that the open end 104 of the steel shell 102 is horizontal. Once oriented, the operation of centrifugal casting includes spinning the superheated, horizontal, worn-out brake drum 100. The spinning is typically at a relatively high rpm (rotations per minute) value. Specifically, the spinning speed is that which imparts the necessary centrifugal force to push the molten iron 112 against the existing gray-iron layer 103 in the worn-out brake drum 100. Accordingly, the precise speed at which the worn-out brake drum 100 is spun will depend on the particular worn-out brake drum 100, especially its diameter and mass. With particular reference to FIG. 3, one example mechanism for spinning the worn-out brake drum 100 is to use one or more spinning rollers 115 that contact the worn-out brake drum 100 and cause it to spin.

Once spinning, the operation of centrifugal casting includes introducing, under the centrifugal force created by the spinning, additional molten iron 112 to the gray-iron layer 103 to increase the radial thickness 110 of the gray-iron layer 103. FIG. 5 illustrates an example of a delivery apparatus (for example, a spout 116) that introduces molten iron 112 to the existing gray-iron layer 103 of a spinning, worn-out brake drum 100. As noted, the centrifugal force created by the spinning causes the additional molten iron 112 to be pushed against the existing (and now superheated) gray-iron layer 103 in the worn-out brake drum 100, allowing the additional molten iron 112 to bond to the superheated gray-iron layer 103.

The method of refurbishing a steel-shell brake drum optionally includes affixing 203 a splash dam 101 to the open end 104 of the steel shell 102 prior to superheating. The splash dam 101 may be affixed by, for example, tack welding or another method. As illustrated in FIGS. 1-5, in configurations the splash dam 101 is a flat, annular plate. In configurations, an inner diameter 117 of the splash dam 101 (as indicated by its radius in the drawing) is less than the rebuilt inner diameter 113 109 of the gray-iron layer 103. An example of this is illustrated in FIG. 5. In configurations having a splash dam 101, the splash dam 101 may be removed from the phase-one brake drum 114 after centrifugal casting. The removal may be, for example, by machining.

The method of refurbishing a steel-shell brake drum also optionally includes determining 201 the structural integrity of the worn-out brake drum 100 prior to superheating. For example, the worn-out brake drum 100 may be inspected for the existence of cracking, failure points, or other imperfections in the steel shell 102 and remaining gray-iron layer 103 that would affect fit, form, or function of the brake drum and, for that reason, not make it a good candidate for refurbishment. Such inspection may occur, for example, upon receipt of a worn-out brake drum 100.

The method of refurbishing a steel-shell brake drum also optionally includes removing 202 rust, debris, and contaminants from the worn-out brake drum 100 prior to superheating. The purpose of this is to prepare the worn-out brake drum 100 for further processing by removing materials that might cause the bonding process of the centrifugal casting to be less effective than desired. This cleaning process may utilize shot blast or other techniques.

The method of refurbishing a steel-shell brake drum also optionally includes machining or otherwise forming one or more circumferential grooves 111 in the gray-iron layer 103 prior to superheating. FIGS. 2 and 4 show examples of such circumferential grooves 111. The circumferential grooves 111 increase the surface area for bonding the new, molten iron 112 to the existing gray-iron layer 103.

The method of refurbishing a steel-shell brake drum also optionally includes cooling the phase-one brake drum 114 and, once cooled, machining 206 the rebuilt inner diameter 113 109 of the gray-iron layer 103 of the phase-one brake drum 114 to a final inner diameter 119 (as indicated by its radius in the drawing) that is required by the relevant specification for the brake drum. For convenience, the resulting brake drum (i.e. the modified phase-one brake drum 114) is subsequently referred to in this specification as a “phase-two brake drum” 118 for ease of referring to this configuration. The example phase-two brake drum 118 illustrated in FIG. 6 also shows that the splash dam 101 has been removed.

The method of refurbishing a steel-shell brake drum also optionally includes preparing 207 the phase-two brake drum 118 for resale and reuse in the field, including by, for example, painting the phase-two brake drum 118.

Accordingly, implementations of the disclosed method not only extend the life of steel shell brake drums but also reduces the production cost, making steel shell drums economically competitive with standard, cast brake drums. By refurbishing the drums, manufacturers can lower the price point and offer a cost-effective alternative to traditional brake drums, providing a competitive edge in the market. Furthermore, implementations of the disclosed refurbishment process reduce the carbon footprint associated with manufacturing new drums, as it decreases the demand for raw materials and the energy consumption associated with producing new steel shells. The rebate program for returning worn-out drums further promotes sustainability by encouraging recycling and reducing waste, thus contributing to a circular economy and supporting environmental conservation efforts.

### Examples

Illustrative examples of the disclosed technologies are provided below. A particular configuration or implementation of the technologies may include one or more, and any combination of, the examples described below.

Example 1 includes a method of refurbishing a steel-shell brake drum, the method comprising: superheating a worn-out brake drum until the worn-out brake drum is glowing hot, the worn-out brake drum comprising a steel shell and a gray-iron layer bonded to an inside surface of the steel shell, the gray-iron layer being worn out, the steel shell having an open end of the steel shell; and centrifugal casting additional molten iron to the gray-iron layer to increase a radial thickness of the gray-iron layer to a rebuilt inner diameter of the gray-iron layer, the result being subsequently referred to in these claims as a phase-one brake drum.

Example 2 includes the method of Example 1, further comprising determining a structural integrity of the worn-out brake drum prior to superheating.

Example 3 includes the method of any of Examples 1-2, further comprising removing rust, debris, and contaminants from the worn-out brake drum prior to superheating.

Example 4 includes the method of any of Examples 1-3, further comprising machining one or more circumferential grooves in the gray-iron layer prior to superheating.

Example 5 includes the method of any of Examples 1-4, in which the operation of centrifugal casting comprises: orienting the worn-out brake drum so that the open end of the steel shell is horizontal; spinning the superheated, horizontal, worn-out brake drum; and introducing, under a centrifugal force created by the spinning, additional molten iron to the gray-iron layer to increase the radial thickness of the gray-iron layer to the rebuilt inner diameter of the gray-iron layer.

Example 6 includes the method of any of Examples 1-5, further comprising, after centrifugal casting: cooling the phase-one brake drum; and machining the rebuilt inner diameter of the gray-iron layer of the phase-one brake drum to a final inner diameter of the gray-iron layer, the result being subsequently referred to in these claims as a phase-two brake drum.

Example 7 includes the method of Example 6, further comprising painting the phase-two brake drum.

Example 8 includes the method of any of Examples 1-7, further comprising affixing a splash dam to the open end of the steel shell prior to superheating, the splash dam comprising a flat, annular plate, an inner diameter of the splash dam being less than the rebuilt inner diameter of the gray-iron layer.

Example 9 includes the method of Example 8, further comprising, after centrifugal casting: cooling the phase-one brake drum; removing the splash dam from the phase-one brake drum; and machining the rebuilt inner diameter of the gray-iron layer of the phase-one brake drum to a final inner diameter of the gray-iron layer, the result being subsequently referred to in these claims as a phase-two brake drum.

Example 10 includes the method of Example 9, further comprising painting the phase-two brake drum.

Example 11 includes a method of refurbishing a worn-out brake drum, the worn-out brake drum comprising a steel shell and a gray-iron layer bonded to an inside surface of the steel shell, the gray-iron layer being worn out, the steel shell having an open end of the steel shell, the method comprising: machining one or more circumferential grooves in the gray-iron layer; affixing a splash dam to the open end of the steel shell, the splash dam comprising a flat, annular plate, superheating the worn-out brake drum until the worn-out brake drum is glowing hot; orienting the worn-out brake drum so that the open end of the steel shell is horizontal; spinning the superheated, horizontal, worn-out brake drum; introducing, under a centrifugal force created by the spinning, additional molten iron to the gray-iron layer to increase a radial thickness of the gray-iron layer to a rebuilt inner diameter of the gray-iron layer, the result being subsequently referred to in these claims as a phase-one brake drum, an inner diameter of the splash dam being less than the rebuilt inner diameter of the gray-iron layer; removing the splash dam from the phase-one brake drum; and machining the rebuilt inner diameter of the gray-iron layer of the phase-one brake drum to a final inner diameter of the gray-iron layer, the result being subsequently referred to in these claims as a phase-two brake drum.

Example 12 includes the method of Example 11, further comprising determining a structural integrity of the worn-out brake drum prior to superheating.

Example 13 includes the method of any of Examples 11-12, further comprising removing rust, debris, and contaminants from the worn-out brake drum prior to superheating.

Example 14 includes the method of any of Examples 11-13, further comprising painting the phase-two brake drum.

*****

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration or implementation, that feature can also be used, to the extent possible, in the context of other example configurations and implementations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations and implementations set forth in this specification. Rather, these example configurations and implementations are provided so that this subject matter will be thorough and complete and will convey the disclosure to those skilled in the art. Indeed, the subject matter is intended to cover alternatives, modifications, and equivalents of these example configurations and implementations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or We) claim:

1. A method of refurbishing a steel-shell brake drum, the method comprising:
superheating a worn-out brake drum until the worn-out brake drum is glowing hot, the worn-out brake drum comprising a steel shell and a gray-iron layer bonded to an inside surface of the steel shell, the gray-iron layer being worn out, the steel shell having an open end of the steel shell; and
centrifugal casting additional molten iron to the gray-iron layer to increase a radial thickness of the gray-iron layer to a rebuilt inner diameter of the gray-iron layer, the result being subsequently referred to in these claims as a phase-one brake drum.

2. The method of claim 1, further comprising determining a structural integrity of the worn-out brake drum prior to superheating.

3. The method of claim 1, further comprising removing rust, debris, and contaminants from the worn-out brake drum prior to superheating.

4. The method of claim 1, further comprising machining one or more circumferential grooves in the gray-iron layer prior to superheating.

5. The method of claim 1, in which the operation of centrifugal casting comprises:
orienting the worn-out brake drum so that the open end of the steel shell is horizontal;
spinning the superheated, horizontal, worn-out brake drum; and
introducing, under a centrifugal force created by the spinning, additional molten iron to the gray-iron layer to increase the radial thickness of the gray-iron layer to the rebuilt inner diameter of the gray-iron layer.

6. The method of claim 1, further comprising, after centrifugal casting:
cooling the phase-one brake drum; and
machining the rebuilt inner diameter of the gray-iron layer of the phase-one brake drum to a final inner diameter of the gray-iron layer, the result being subsequently referred to in these claims as a phase-two brake drum.

7. The method of claim 6, further comprising painting the phase-two brake drum.

8. The method of claim 1, further comprising affixing a splash dam to the open end of the steel shell prior to superheating, the splash dam comprising a flat, annular plate, an inner diameter of the splash dam being less than the rebuilt inner diameter of the gray-iron layer.

9. The method of claim 8, further comprising, after centrifugal casting:
cooling the phase-one brake drum;
removing the splash dam from the phase-one brake drum; and
machining the rebuilt inner diameter of the gray-iron layer of the phase-one brake drum to a final inner diameter of the gray-iron layer, the result being subsequently referred to in these claims as a phase-two brake drum.

10. The method of claim 9, further comprising painting the phase-two brake drum.

11. A method of refurbishing a worn-out brake drum, the worn-out brake drum comprising a steel shell and a gray-iron layer bonded to an inside surface of the steel shell, the gray-iron layer being worn out, the steel shell having an open end of the steel shell, the method comprising:
machining one or more circumferential grooves in the gray-iron layer;
affixing a splash dam to the open end of the steel shell, the splash dam comprising a flat, annular plate,
superheating the worn-out brake drum until the worn-out brake drum is glowing hot;
orienting the worn-out brake drum so that the open end of the steel shell is horizontal;
spinning the superheated, horizontal, worn-out brake drum;
introducing, under a centrifugal force created by the spinning, additional molten iron to the gray-iron layer to increase a radial thickness of the gray-iron layer to a rebuilt inner diameter of the gray-iron layer, the result being subsequently referred to in these claims as a phase-one brake drum, an inner diameter of the splash dam being less than the rebuilt inner diameter of the gray-iron layer;
removing the splash dam from the phase-one brake drum; and
machining the rebuilt inner diameter of the gray-iron layer of the phase-one brake drum to a final inner diameter of the gray-iron layer, the result being subsequently referred to in these claims as a phase-two brake drum.

12. The method of claim 11, further comprising determining a structural integrity of the worn-out brake drum prior to superheating.

13. The method of claim 11, further comprising removing rust, debris, and contaminants from the worn-out brake drum prior to superheating.

14. The method of claim 11, further comprising painting the phase-two brake drum.
